(19) United States
(12) Patent Application Publication
(10) Pub. No.: US 2015/0135567 A1
(43) Pub. Date: May 21, 2015

(54) LICENSE PLATE FRAME VEHICLE PROTECTOR

(71) Applicants: Ronnie Malina, Nanuet, NY (US); Eric Malina, Nanuet, NY (US)

(72) Inventors: Ronnie Malina, Nanuet, NY (US); Eric Malina, Nanuet, NY (US)

(21) Appl. No.: 14/549,675

(22) Filed: Nov. 21, 2014

Related U.S. Application Data
(63) Continuation-in-part of application No. 61/906,976, filed on Nov. 21, 2013.

(51) Int. Cl. B60R 13/10

(52) U.S. Cl. CPC B60R 13/105
USPC 40/209

(57) ABSTRACT

The present disclosure relates to the field of vehicle protectors and more particularly to automobile license plate frame bumper protectors.

### CROSS REFERENCE TO RELATED APPLICATIONS

This application claims the benefit of U.S. Ser. No. 61/906,976, filed on Nov. 21, 2013 (and entitled, “License Plate Frame Vehicle Protector”), which is incorporated in its entirety herein by reference.

### BACKGROUND OF THE INVENTION

1. Field of the Invention

The present invention generally relates to vehicle protectors and more particularly to automobile license plate frame bumper protectors.

Specifically, the present invention relates to automobile license plate frame bumper protectors that can both easily receive and position the license plate in a frame that also protects the automobile's bumper. The present design achieves this with heretofore unrealized results.

2. Description of the Related Art

Vehicle bumpers can be damaged when parked on the street, especially from contact made by other vehicles backing into the vehicle as may occur during parking

Generally known in the art are protective license plate frames made of a sturdy impact resistant rubber material to help prevent front bumper damage caused by vehicles making contact when parking

Automobiles commonly have four bolts that hold a license plate in place, however most automobiles only utilize the top two bolts. A common method for installing the protective license plate frames known in the art use an open back screw together system, meaning, the license plate is held to the product with the license plate bolts, usually using the top two bolts, as two separate pieces. The license plate thus sits independently between the vehicle bumper and the frame.

The foregoing mounting arrangement has disadvantageous, among other reasons, because it holds license plates in a manner that may not be as secure as otherwise possible. Furthermore, the aforementioned mounting arrangement may permit undesirable contact between the license plate and the vehicle body/bumper.

Further disadvantages of the prior art include having a design that easily accommodates positioning the license within the frame itself For example, when the opening for insertion of the license plate is on its bottom, since the majority of vehicles only mount with the top two screws, the area between the bottom bolts dangles freely and the license plate has little support or rigidity. This weakens the integrity of the license plate frame. If, on the other hand, the opening for insertion of the license plate is on the side, similar problems arise. The lack of support by the bolts on the side of the license plate often results in the license plate frame sagging or sloping forward and thus failing to keep the license plate securely in place. Another problem with having a side opening is that the license plate needs to slide across a longer distance of the frame because most license plates are rectangular in shape. The additional resistance against the rubber, and the force with which a person has to push the license plate in order for it to be completely within the frame is often difficult and frequently causes the license plate to bend. It may also result in a misshapen frame.

Accordingly, there is now provided with this invention an improved license plate frame vehicle protector effectively overcoming the aforementioned difficulties and longstanding problems inherent in housing a license plate and protecting an automobile's bumper.

### SUMMARY OF THE INVENTION

According to one aspect of certain embodiments of the invention, a license plate frame vehicle protector is disclosed having a body. The body may have a front face, a back wall (also called a “rear wall” or “rear face”), a top edge, side edges, and a bottom edge. A housing may be formed in the body for receiving a license plate. The license plate frame vehicle protector also may have an opening formed in the body in communication with the housing.

According to another aspect, the present invention may include a license plate frame vehicle protector having a body that has an outside top edge, outside side edges, and rounded corners therebetween. The body may have an inner perimeter with a slit extending around the inside thereof for housing a license plate. An opening may be in the outside top edge and extends around at least a portion of the rounded edges. The opening may be in communication with the slit.

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

The method and apparatus of the present invention will be better understood by reference to the following detailed discussion of specific embodiments and the attached figures which illustrate and exemplify such embodiments.

### BRIEF DESCRIPTION OF THE DRAWINGS

The objects and features of the invention may be understood with reference to the following detailed description of an illustrative embodiment of the present invention taken together in conjunction with the accompanying drawings in which:

FIG. 1 is a front view of one embodiment of the license plate frame vehicle protector.

FIG. 2 is a bottom view of the embodiment of FIG. 1.

FIG. 3 is one side view of the embodiment of FIG. 1.

FIG. 4 is an opposite side view of the embodiment of FIG. 1.

FIG. 5 is a rear view of the embodiment of FIG. 1.

FIG. 6 is a top view of the embodiment of FIG. 1.

FIG. 7 is a front view of another embodiment of the license plate frame vehicle protector.

FIG. 8 is a bottom view of the embodiment of FIG. 7.

FIG. 9 is a rear view of the embodiment of FIG. 7.

FIG. 10 is a side view of the embodiment of FIG. 7.

FIG. 11 is an opposite side view of the embodiment of FIG. 7.

FIG. 12 is a top view of the embodiment of FIG. 7.

### DESCRIPTION OF THE PREFERRED EMBODIMENT

The following preferred embodiment as exemplified by the drawings is illustrative of the invention and is not intended to limit the invention as encompassed by the claims of this application.

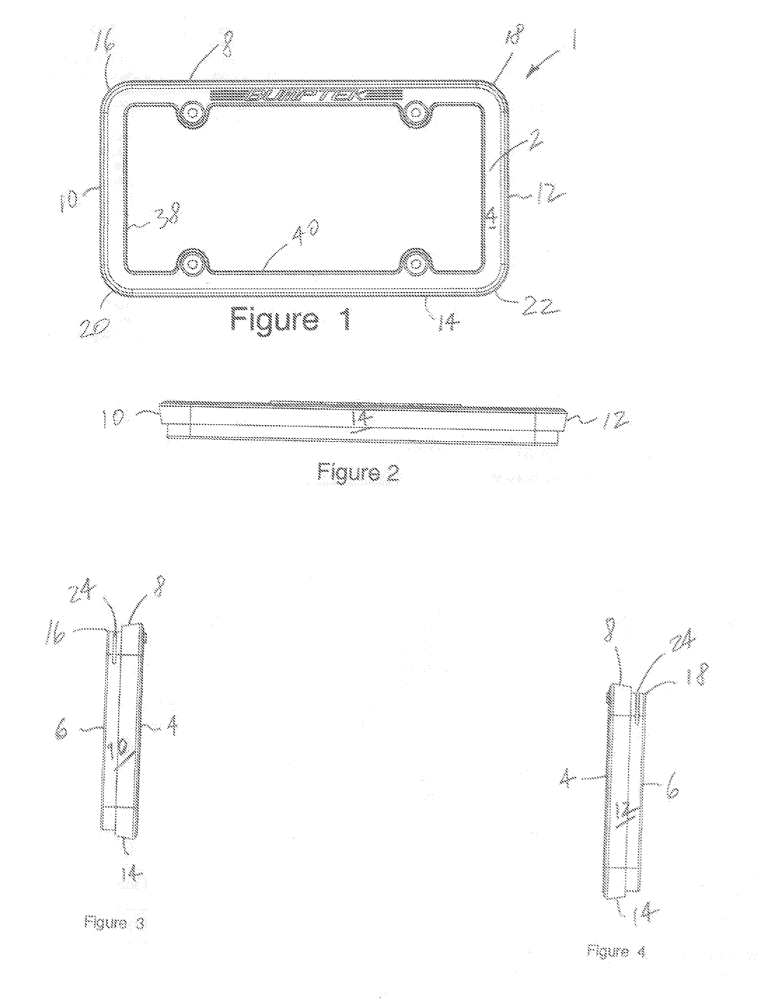

A license plate frame vehicle protector is disclosed herein. The front view of one embodiment of the license plate frame vehicle protector 1, is illustrated in FIG. 1. The license plate frame vehicle protector has a body 2. The body 2 has a front face 4, a back wall 6, a top edge 8, side edges 10 and 12, and a bottom edge 14. The body may include rounded edges 16 and 18 joining the top edge 8 with the side edges 10 and 12, respectively. The body may further include rounded edges 20 and 22 joining the bottom edge 14 with the side edges 10 and 12, respectively.

FIG. 2 more particularly shows the bottom edge 14 of the body shown in FIG. 1.

FIGS. 3 and 4 show side views of the body shown in FIG. 1 and illustrate an opening 24 in the top edge of the body. As shown in FIGS. 3 and 4, the opening 24 extends at least partially around rounded corner 16 (shown in FIG. 3) and at least partially around rounded corner 18 (shown in FIG. 4). That is, the opening 24 extends around at least a portion of the rounded edges. Alternatively, the opening may extend around a majority of the rounded edges or completely around one or both of the rounded edges. Having the opening on the top, versus the bottom or side, after the adjustments and implementations made below, enables the plate to slide in easily and sit snugly within the product, while fastened securely to the vehicle. As shown therein, the opening may be formed towards the back wall of the license plate frame vehicle protector. Alternatively, the opening may be formed towards the front face of the license plate frame vehicle protector. The opening on the top of the frame in effect separates the front face from the back wall which otherwise weakens the integrity and structure of the product, but is necessary to allow the license plate insertion.

Further illustrated in FIGS. 3 and 4 is that the front face 4 is wider than the back wall 6. This helps to accommodate most standard license plate brackets into the body. By having the front face 4 wider than the back wall 6 increased surface area and maximum protection of the vehicle is provided.

Typically, the opening 24 (also called a “notch”) extends around at least a portion of the rounded edges. The opening extending around at least a portion of the rounded edges preferably extends approximately 1 inch down from the top edge of the opening. This extension allows for a greater range of motion with which to insert the license plate into the body by being able to come in on an angle versus straight in from the top. This significantly increases the ease at which a user may insert the license plate and simultaneously decreases the chance of damaging the plate or the product due to too much friction between the two. The extension of the opening around at least a portion of the rounded edges also allows for a greater degree of flexibility in the back wall. This may be important because it makes inserting or removing the product much easier because the frame may be more easily spread apart more to grab the license plate, thereby increasing the grip and control one has over both the plate and the product. Finally, it may be an important advantage of having the opening extend around at least a portion of the rounded edges is providing sufficient flexibility in the body to absorb the force necessary to remove or insert the license plate.

In typical operation, the user slides the license plate through the opening into the body. By placing the opening on the top edge of the body, a housing 38, sometimes called “a pocket” is thereby formed by the remaining three sides of the body to accommodate the license plate and thereby encasing the license plate within the protective frame. The housing is an integral function of the license plate frame vehicle protector and is formed by having a slit 40 around the inside perimeter of the body to hold and to frame the license plate. Thus, the body has an inner perimeter with a slit extending around the inside thereof for housing the periphery of an inserted license plate. The housing 38 is sealed on its bottom and frames and holds the license plate in place.

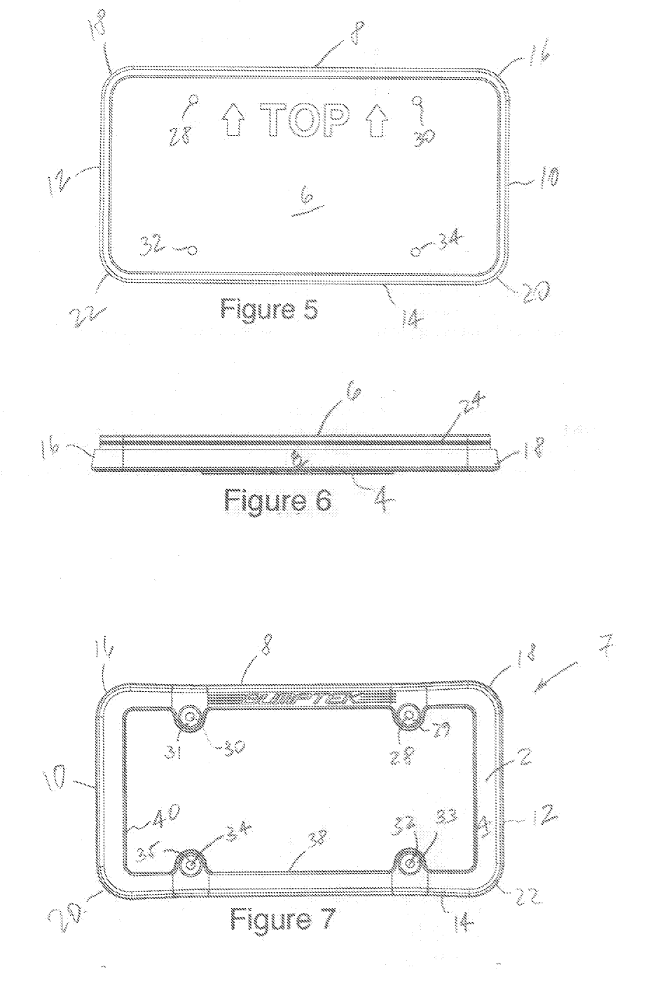

FIG. 5 illustrates the back wall 6 of the body of the license plate frame vehicle protector. Typically, the back wall is closed across its entire face. Two holes 28 and 30 are shown towards the top of the body and two holes 32 and 34 are shown towards the bottom of the body. Although four holes are shown, one embodiment of the license plate frame vehicle protector may only include two. The holes extend from the front face through to the back wall and are aligned with the mounting holes typically positioned on license plates. The holes may also be recessed into the front face of the license plate frame vehicle protector. Eyelets 29, 31, 33, and 35 may be provided in each hole for each through connector. Such eyelets may be integrated with the holes.

The four eyelets on the front of the product encapsulate the connectors, making them recessed from the surface, thereby preventing damage to other vehicles. The top two holes may be essential to the functionality of the license plate frame vehicle protector. Having integrated eyelets may further enhance this functionality by bringing additional stability and rigidity to the product by strengthening the top portion once the screws are inserted, which is otherwise weakened by the opening through which the license plate slides into the frame.

FIG. 6 more particularly illustrates the opening 24 extending along the top edge 8 and past the rounded corners 16 and 18. FIG. 6 also shows the front face 4 wider than the back wall 6.

FIG. 7 is a front view of another embodiment of the license plate frame vehicle protector having the body 2 that has the front face 4, the back wall 6, the top edge 8, the side edges 10 and 12, and the bottom edge 14. The body may include the rounded edges 16 and 18 joining the top edge 8 with the side edges 10 and 12, respectively. The body may further include the rounded edges 20 and 22 joining the bottom edge 14 with the side edges 10 and 12, respectively.

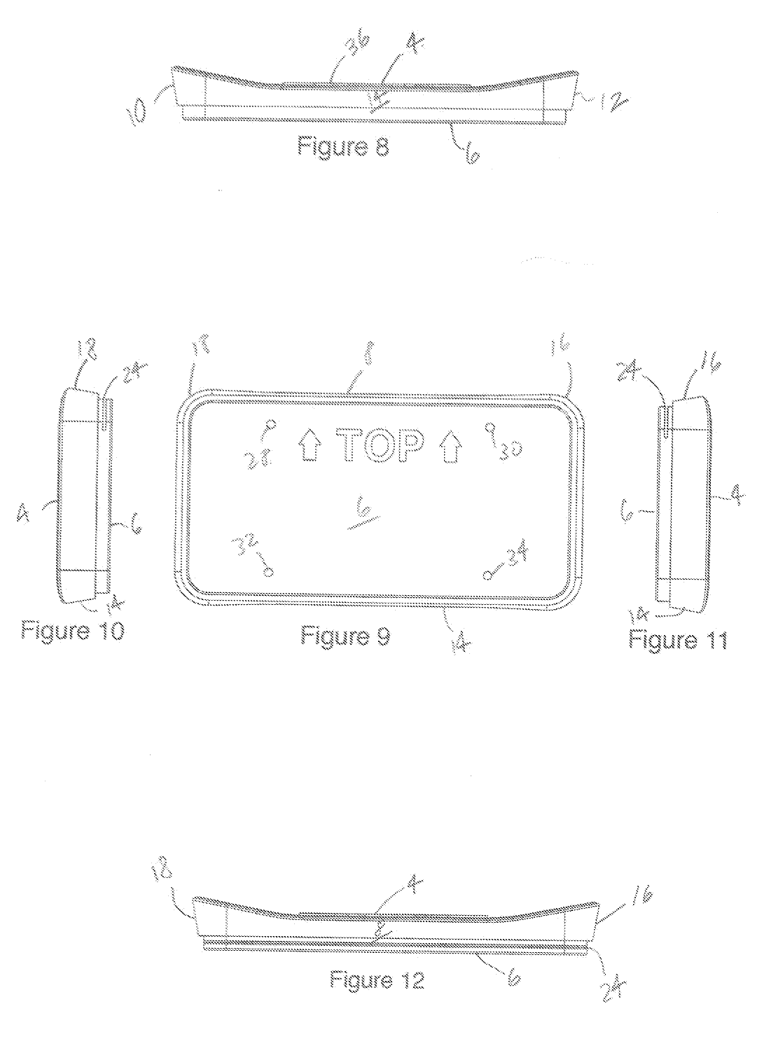

FIG. 8 shows the bottom view of the license plate frame vehicle protector embodiment of FIG. 7. As depicted therein, the front face has sides 10 and 12 that protrude from the back wall more than does a central portion 36 of the front face.

FIG. 9 illustrates a rear view of the license plate frame vehicle protector embodiment of FIG. 7 and FIGS. 10 and 11 show opposite side views. The opening 24 is in the top edge of the body. As shown more particularly in FIGS. 10 and 11, the opening 24 extends around at least a portion of the rounded corner 16 (shown in FIG. 11) and rounded corner 18 (shown in FIG. 10). Alternatively, the opening may extend around a majority of the rounded edges or around the entirety of one or both of the rounded edges. As shown therein, the opening is positioned towards the back wall of the license plate frame vehicle protector. Alternatively, the opening and the housing may be formed towards the front face of the license plate frame vehicle protector. Further illustrated in FIGS. 10 and 11 is that the front face 4 is wider than the back wall 6.

Since most license plates only mount using the top two screws, the housing keeps the license plate secured and in place within the frame. It prevents the bottom of the license plate from separating from the body (since it would not be fastened) and dangling freely, and making the license plate more susceptible to damage. Additionally, for vehicles that do not have built-in license plate brackets, the housing creates a barrier between the metal license plate, and the surface of the vehicle, which prevents scratching and damage caused by their contact.

One benefit of the license plate frame vehicle protector design is that it holds the license plate firmly in place without having to drill excess holes in the vehicle (because, as previously mentioned, the majority of vehicle license plates are held in place using only the top two bolts).

Certain embodiments of the present invention may also be made to function properly in conjunction with vehicles that use four bolts by including open holes to accommodate any additional screws. In such embodiments, once a license plate is inserted into the device and the top two connectors are secured (typically either bolts or screws), the device locks the license plate in place, with the top opening being effectively semi-sealed so that the license plate is secure and cannot be readily removed.

Although the particular embodiments shown and described above will prove to be useful in many applications in the automotive arts to which the present invention pertains, further modifications of the present invention will occur to persons skilled in the art. All such modifications are deemed to be within the scope and spirit of the present invention as defined by the appended claims.

1-10. (canceled)

11. A license plate frame vehicle protector, comprising:
a) a body having a front face, a flexible back wall, a top edge, side edges, and a bottom edge;
b) a housing formed in the body for receiving a license plate; and
c) an opening formed in the body in communication with the housing wherein the flexible back wall is more flexible than the front face.

12. The license plate frame vehicle protector of claim 11, wherein the body has rounded corners bridging the top edge and the side edges.

13. The license plate frame vehicle protector of claim 12, wherein the opening extends around at least a portion of the rounded edges.

14. The license plate frame vehicle protector of claim 13, extends around a majority of the rounded edges.

15. The license plate frame vehicle protector of claim 14, wherein the body has at least two holes recessed from the front face wherein each hole has an eyelet therethrough.

16. The license plate frame vehicle protector of claim 15, wherein the front face is wider than the back wall.
